(19) United States
(12) Patent Application Publication
(10) Pub. No.: US 2026/0141442 A1
(43) Pub. Date: May 21, 2026

(54) UPDATING PAYEE ATTRIBUTES FOR ELECTRONIC PAYMENTS, BASED ON A COMMUNICATED CHANGE

(71) Applicant: MOTOROLA MOBILITY LLC, WILMINGTON, DE (US)

(72) Inventors: AMIT KUMAR AGRAWAL, BANGALORE (IN); VIJAYPRAKASH IDLUR, BANGALORE (IN); PANDURANGA REDDY PAILLA, NALGONDA (IN)

(21) Appl. No.: 18/950,116

(22) Filed: Nov. 17, 2024

(51) Int. Cl. G06Q 40/02

(52) U.S. Cl. CPC G06Q 40/02

(57) ABSTRACT

An electronic device, a method, and a computer program product manage an automated update of payee attribute(s) in a payee contact used for electronic payments, the update based on a communicated change. The electronic device maintains a payee contact having payee attribute(s) of a payee used for a future payment. In response to identifying a reported change of the payee attribute(s) associated with the future payment, the electronic device generates and presents, via output device(s) of the electronic device, a notice of the reported change required in at least one payee attribute associated with the transaction. In response to receiving a user input to record a corresponding change to the payee attribute(s) corresponding to the reported change, the electronic device updates the payee attribute(s) stored in the payee contact with the communicated payee attribute(s) associated with the future payment for the transaction.

### BACKGROUND

### 1. Technical Field

The present disclosure relates generally to electronic devices that maintain electronic information in stored contacts, and more particularly to electronic devices that communicate with payment services using the electronic information stored in the contacts.

### 2. Description of the Related Art

Electronic devices such as smartphones, desktop laptops, and tablets are increasingly being used by users for a wide range of productivity and entertainment uses. In an example, financial institutions offer electronic banking and payment services that user electronic devices can access. Providers of goods and services can provide payment information to their customers that can be used from the customer's electronic device to quickly and efficiently initiate a payment. For ad hoc or scheduled future payments, a user may prefer to store this payment information on the electronic device for further convenience. Authorizing the next payment may be accomplished with an automated reminder that presents one or more controls to initiate the payment.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of a communication device in which the features of the present disclosure are advantageously implemented for updating of payee attribute(s), which is stored in a payee contact, for electronic payments, based on a communicated change, according to one or more embodiments;

FIG. 2 is a simplified block diagram of the communication device having additional communication interfaces for wireless communications within a communication environment, according to one or more embodiments;

FIG. 3 illustrates a communication record presented in an email interface window on a display of the communication device and that notifies of a payee attribute change, according to one or more embodiments;

FIG. 4 illustrates a payment interface window with payee contact update popup presented on the display of the communication device in response to the payee attribute change, according to one or more embodiments;

FIG. 5 is a flow diagram presenting a method for updating of payee attributes in a payee contact for electronic payments based on a communicated change, according to one or more embodiments; and

FIG. 6 is a flow diagram presenting a method for initiating the electronic payment using the updated payee attributes, according to one or more embodiments.

### DETAILED DESCRIPTION

According to aspects of the present disclosure, an electronic device, a method and a computer program provide techniques for updating payee attributes in a payee contact for a scheduled electronic payment based on a communicated change. The present disclosure facilitate electronic payments for previously communicated changes in payment payee attributes that a user may overlook. Aspects of the present disclosure support increasing adoption of instant money transfers using digital banking via user electronic devices. Digital banking includes functionality such as 24-7 access, instant money transfers, virtual banking interactions, and withdrawing cash from an automatic teller machine using the electronic device for authentication instead of a debit card or credit card. More transactions may be facilitated without using cash or debit/credit card. In part, financial transactions may be directed to accounts associated with telephone numbers or contact names instead of necessarily knowing the associated financial institution name, bank routing number, and account number. In one of more embodiments, the present disclosure is implemented to support a unified payment interface for instant mobile payments using a payment account identifier such as a telephone number or email address. While being very fast and convenient, relying upon use of a nondescriptive telephone number or other payment identifier, may create situations where a future payment, such as an ad hoc payment or an ongoing periodic/scheduled payment, is made to the incorrect payee. Situations can arise where a payee changes bank accounts and/or a vendor payee is switched from a first vendor to another vendor, which continues to provide a paid-for service that requires an electronic payment, but requiring payment be made to a different payee account than one stores on the customer's device. The upcoming/scheduled change in the vendor and/or payment accounts can be communicated via an email of text notification to the customer's device, but the notification is not immediately acted upon to update the associated payee attribute. Subsequent payments are thus made to the wrong vendor or to the wrong vendor account, which can lead to a loss of funds if the payment cannot be retrieved or the inconvenience of having to try to track the payment down and also make payment to the correct vendor or to the correct vendor payment account.

One or more aspect of the present disclosure addresses how to manage and verify payee (e.g., vendor) information before payment is made when a change in the current payee or payee account has occurred and has been electronically communicated to the customer, who is the user of the electronic device. As an example, a venue may be at the same location but have a different entity providing the goods or services at the location. In an example, a bodega or grocery store may exist in a space in an apartment or business office. Owners of the apartment or business office may contract with different business entities to run the business in the space. In another example, a school uniform store, canteen, or school supply business may exist in a school. The business entity that operates this space may be changed by school administrators. Each different business entity (payee) can have a different payee account to receive payment from its registered customers/payors. For the customers and the payees alike, having the right payee and/or payee account is important so that the payment for and receipt of the goods or services is not interrupted and so that money is not lost by being sent to the wrong payee/payee account. In an additional example, a tutor or personal coach may change their personal name, which may affect whether a payment transaction may be successfully initiated. The financial institution may require that all provided data fields correspond to the payee's current information.

To address these and other challenges, the present disclosure provides techniques for automating the deletion of obsolete payee attributes and updating relevant goods or service provider contacts when a communication indicating a change is to be made is received at the payor device. In an example, a new service provider notification may be received via email, short message service (SMS), text, or application direct message. The present disclosure can allow a user to label the provider of a goods or service generically, such as “My son's cafeteria” or “My dog walking service”, particularly when the specific name of the provider is not as recognizable, and the change in a provider or provider payment account can then be completed in the background without having to specifically update the user view of the payment transaction to the current provider associated with the label. The required payee attributes are updated to enable ad hoc, periodic, recurring, or scheduled future payments to be accurately transacted.

In an example, the updating processes provided by the present disclosure avoids the potential negative repercussions of a user overlooking or not being aware of a crucial email notification about one bank acquiring another bank, the latter bank being the one that currently provides banking services for a payee, but is now being replaced. The email may have gone to spam since the acquiring bank did not have a previous relationship with the user and was not designated in a safe email or domain list. In another example, the school cafeteria may change management. Maintaining a positive money balance in an account used by the current cafeteria management may be required for a student to eat. A next recurring deposit into the account of the old management company may occur automatically, while the new management company account is not funded, resulting in the student not having a balance available to purchase his lunch. In both instances, errors in payment information may result in lost time and money. Interruption in the delivery of goods or providing of services may create at least an inconvenience to the user, such as the student not getting lunch.

In one or more embodiments, migration or modification of payment particulars of service providers for online payments via an electronic wallet is facilitated. In some embodiments, the electronic device maintains ad hoc/recurring/periodic/scheduled future payment information associated with a payee. The electronic device maintains payee attributes of the payee that are necessary or helpful in a contact of a user's personal knowledge base (PKB). In an example the payee attributes include a payee name, a payee address, a receiving payment entity such as a payment app or bank, unique payment account identifier (e.g., telephone number). The electronic device at least periodically monitors communication records (e.g., short message service (SMS), application direct messages, or emails) to determine whether one or more payee attribute has changed. In an example, the present disclosure includes determining an expired contract for a service provider by searching communication records. A payment user interface is presented to facilitate updating the (future) payment information when an old provider (i.e., first payee) is changed to a new provider (i.e., second payee). Additionally, in some embodiments, the payment user interface is presented to facilitate updating the payment information when a current provider changes a payment account with a corresponding new payment account identifier.

In one or more embodiments, the user device is an electronic device that includes at least one input device and at least one output device. The electronic device includes a memory including (i) a personal knowledge base comprising a payee contact having at least one payee attribute of a payee; and (ii) a payment module for a transaction including a future payment to the payee using at least in part the at least one payee attribute. The electronic device includes a communications subsystem that links the electronic device to at least one payment system having a payment account associated with the payee. A processor of the electronic device is communicatively coupled to the at least one input device, the at least one output device, the memory, and the communications subsystem. In response to identifying a reported change of the at least one payee attribute associated with the future payment to the payee associated with the transaction, the processor is configured to cause the electronic device to generate and present a notice, via the at least one output device, of the reported change required in at least one payee attribute associated with the transaction. In response to receiving a user input to record a corresponding change to the at least one payee attribute corresponding to the reported change, the processor is configured to cause the electronic device to update the at least one payee attribute stored in the payee contact associated with the future payment for the transaction. Subsequent payments to the payee are then completed using the updated payee attributed.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined primarily by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

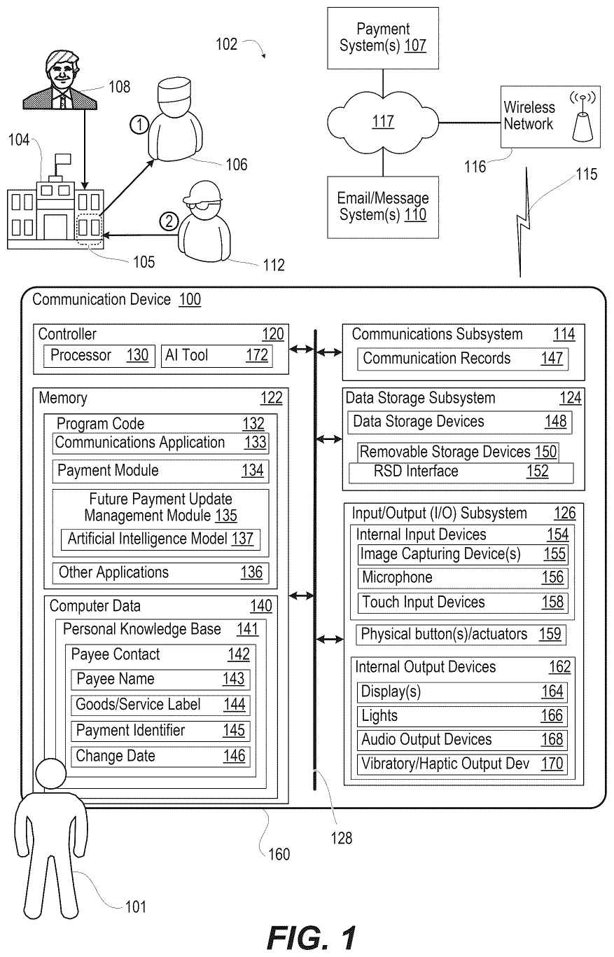

FIG. 1 presents a simplified functional block diagram of an electronic device in which the features of the present disclosure are advantageously implemented for updating of payee attributes, which is stored in a payee contact, for recurring/periodic/scheduled electronic payments, based on a communicated change. In one or more embodiments, the electronic device includes additional communications functionality that enables electronic device to be referred to as communication device 100, which operates as a mobile user device for user 101 in communication environment 102. Communication device 100 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 100 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices.

In the specific example of FIG. 1, communication environment 102 supports transaction of ad hoc/recurring/scheduled future payments for goods and services and supports communicating information to a user device about the future payment(s). In an example, a facility or institution 104 has venue 105 operated at a first time “1” by first payee 106. Communication device 100 facilitates an online future payment on behalf of user 101 via payment system(s) 107. In the illustrated example environment, manager 108 of institution 104 communicates, via Email/Message system(s) 110 to communication device 100, a change from first payee 106 to second payee 112 at a second time “2” that affects ad hoc/recurring/scheduled future payments. In an example, the change is communicated as part of a short message service (SMS) text, an email, an application direct message, a facsimile message, or other information transmission.

Communications device 100 includes communications subsystem 114 that connects via wired or wireless channel 115 to node 116 (e.g., wireless access point, cellular tower) to communicatively connect to payment system(s) 110 via one or more communication network(s) generally presented as network(s) 117.

In addition to communications subsystem 114, communication device 100 includes controller 120, memory 122, data storage subsystem 124 and input/output (I/O) subsystem 126. To enable management by controller 120, system interlink 128 communicatively connects controller 120 with communications subsystem 114, memory 122, data storage subsystem 124 and I/O subsystem 126. System interlink 128 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 128) are illustrated in FIG. 1, it is to be understood that more, fewer, or different interconnections may be present in other embodiments.

Controller 120 includes processor 130, which includes one or more central processing units (CPUs) or data processors. Processor 130 can include one or more digital signal processors and graphics processing units (GPUs), etc. that can be integrated with data processor(s). Processor 130 can include other processors such as auxiliary processor(s) that may act as a low power consumption, always-on sensor hub for physical sensors. Controller 120 manages, and in some instances directly controls, the various functions and/or operations of communication device 100. These functions and/or operations include, but are not limited to including, application data processing, communication, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

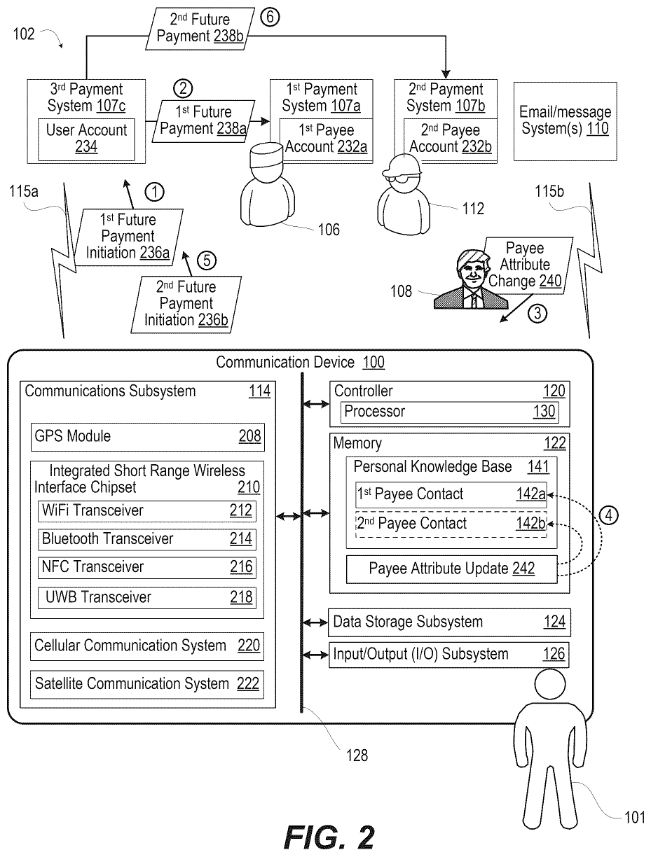

Memory 122 stores program code 132 for execution by processor 130 to provide the functionality described herein. Memory 122 further includes operating system (OS), firmware interface, such as basic input/output system (BIOS) or Uniform Extensible Firmware Interface (UEFI), and firmware, which also includes and may thus be considered as program code 132. Program code 132 includes applications such as communications application 133 for receiving, via communications subsystem 114, email/message containing the change. Program code 132 may include payment module 134 for initiating future payment(s) via payment system(s) 107. An example of future payments is described below with regard to FIG. 2. With continued reference to FIG. 1, program code 132 includes a future payment update management (FPUM) module 135 for dynamically updating payee attributes to efficiently and accurately facilitating future payments being made to the correct payee and payee account. Program code 132 may include other applications 136. FPUM module 135 may include artificial intelligence (AI) model 137 for identifying payee attribute changes in communication records. In one or more embodiments, several of the described aspects of the present disclosure are provided via executable program code of applications executed by controller 120. In one or more embodiments, program code 132 may be integrated into a distinct chipset or hardware module as firmware that operates separately from executable program code. Portions of program code 132 may be incorporated into different hardware components that operate in a distributed or collaborative manner.

Program code 132 may access, use, generate, modify, store, or communicate computer data 140, such as personal knowledge base (PKB) 141 that includes payee contact(s) 142 for FPUM module 135 to dynamically manage future payments responsive to identifying payee attribute changes. In one or more embodiments, payee attributes can include information that facilitates sending emails/messages to first or second payee 106 and 112, to physically mail correspondence to a business address, a website, or telephone number. In an example, communication device 100 may trigger printing of a paper bank check for insertion into an addressed envelope that is to be mailed to complete the payment. As depicted in FIG. 1, payee contact 142 includes payee name 143, goods/service label 144, payment identifier 145, and change date 146. In an example, payee name 143 for the same payee, such as first payee 106, may change when a business name for the same entity changes. In response to identifying a change from first payee 106 having payee contact 142 to second payee 112 not having a payee contact, communication device creates a new payee contact for second payee 112. User 101 may not find payee name 143 to be sufficiently informative of what the future payment is for. Goods/service label 144 allows automated or manual labeling of payee contact 142 to associate with a location, type of goods and service, or nickname that is more intuitive for user 101. Examples of goods/service label 144 include “my son's school café”, “my dog walker”, my lawn watering maintainer”, etc. Payment identifier 145 may be payment application identification, a telephone number, an email address, wire transfer identification, debit/credit card identifications (e.g., number, expiration date, security code, name, etc.), or a checking account number and bank routing number. Change date 146 is the effective date of the change in the payment attribute(s). In an example, the change may be effective immediately. In another example the change may be effective at a specified future date.

Computer data 140 may incorporate “data” that originated as raw, real-world “analog” information that consists of basic facts and figures. Computer data 140 includes different forms of data, such as numerical data, images, coding, notes, and financial data. Computer data 140 may originate at communication device 100 or be retrieved from a remote device via communications subsystem 114. Communication device 100 may store, modify, present, or transmit computer data 140, such as payee contact 142. Computer data 140 may be organized in one of a number of different data structures. Common examples of computer data 140 include video, graphics, text, and images. Computer data 140 can also be in other forms of flat files, databases, and other data structures. In one or more embodiments, FPUM module 135 may access communication records 147 that contain the change in the payment attribute(s). In an example, communication records 147 are accessed via communications subsystem 114 or are stored in memory 122 as computer data 140.

Data storage subsystem 124 of communication device 100 includes data storage device(s) 148. Controller 120 is communicatively connected, via system interlink 128, to data storage device(s) 148. Data storage subsystem 124 provides program code 132 and computer data 140 stored on nonvolatile storage that is accessible by controller 120. For example, data storage subsystem 124 can provide a selection of program code 132 and computer data 140. These applications can be loaded into memory 122 for execution/processing by controller 120. In one or more embodiments, data storage device(s) 148 can include hard disk drives (HDDs), optical disk drives, and/or solid-state drives (SSDs), etc. Data storage subsystem 124 of communication device 100 can include removable storage device(s) (RSD(s)) 150, which is received in RSD interface 152. Controller 120 is communicatively connected to RSD 150, via system interlink 128 and RSD interface 152. In one or more embodiments, RSD 150 is a non-transitory computer program product or computer readable storage device that stores program code and/or instructions that may be executed by a processor associated with a user device such as communication device 100. Controller 120 can access data storage device(s) 148 or RSD 150 to provision communication device 100 with program code 132 and computer data 140.

I/O subsystem 126 may include internal input devices 154 such as image capturing device(s) 155, microphone 156, and touch input devices 158 (e.g., screens, keys, or buttons). I/O subsystem 126 may include physical buttons/actuators 159 that can be located on a periphery of the device housing 160. I/O subsystem 126 may include internal output devices 162 such as display(s) 164, lights 166, audio output devices 168, and vibratory or haptic output devices 170.

FPUM module 135 and AI model 137 may be stored in memory 122 of communication device 100 and be executed by controller 120 to perform various aspects of the functionality of the present disclosure. Training of AI model 137 is the process by which AI models are trained to perform specific tasks or achieve certain objectives. The training involves providing the model with a large amount of data and allowing the model to learn from patterns and relationships within that data. Controller 120 may include various functionalities, such as an integrated AI tool 172, that enable controller 120 to perform different aspects of AI models. AI models may include an artificial neural network, a decision tree, a support vector machine, Hidden Markov model, linear regression, logistic regression, Bayesian networks, and so forth. The AI models can be individually trained to perform specific tasks and can be arranged in different sets of AI models to generate different types of output.

FIG. 2 is a simplified block diagram of communication device 100 having additional communication interfaces for wireless communications within connected device ecosystem and with other devices. In one or more embodiments, controller 120, via communications subsystem 114, performs multiple types of cellular over-the-air (OTA) or wireless communication, such as by using a Bluetooth connection or other personal access network (PAN) connection. In an example, a user may wear a health monitoring device such as a smartwatch that is communicatively coupled via a wireless connection. In one or more embodiments, communications subsystem 114 includes a global positioning system (GPS) module 208 that receives GPS broadcasts from GPS satellites to obtain geospatial location information. In one or more embodiments, controller 120, via communications subsystem 114, communicates via a wireless local area network (WLAN) link using one or more IEEE 802.11 WLAN protocols with an access point. In one or more embodiments, controller 120, via communications subsystem 114, may communicate via an OTA cellular connection with radio access networks (RANs). In an example, communication device 100, via communications subsystem 114, connects via RANs of a terrestrial network that is communicatively connected to a network server. In one or more embodiments, communications subsystem 114 includes integrated short range wireless interface chipset 210 having one or more of Wi-Fi component 212, Bluetooth (BT) transceiver (TxRx) 214, near field communication (NFC) transceiver 216, and ultra-wideband transceiver 218. In one or more embodiments, communications subsystem 114 further includes long distance communication capabilities including cellular communication system 220 and satellite communication system 222.

According to aspects of the present disclosure, the additional communication capabilities of communication device 100 enable communication device to detect and respond to changes in payee attribute(s) that affect a future payment that is to be electronically triggered by communication device 100. Communication environment 102 includes first payment system 107a, second payment system 107b, and third payment system 107c. First payment system 107a manages first payee account 232a for first payee 106. Second payment system 107b manages second payee account 232b for second payee 112. Third payment system 107c manages user account 234 for user 101. Communication device 100 maintains PKB 141 containing first payee contact 142a associated with first payee 106 and containing payee attributes required to initiate a payment to first payee account 232a. At first time “1”, communication device 100 generates first future payment initiation information 236a using first payee contact 142a. Communication device 100 also transmits, via communications subsystem 114 and wired or wireless channel 115a, first future payment initiation information 236a to third payment system 107c. At a second time “2”, third payment system 107c uses payee attributes included in first future payment initiation information 236a to generate and transmit first future payment 238a to first payee account 232a via first payment system 107a. At a third time “3”, email/message system(s) 110 transmits, via wired or wireless channel 115b, payee attribute change information 240 (e.g., as/within SMS, email, direct message) originated by manager 108. Communication device 100 receives payee attribute change information 240 and identifies a payee attribute update 242 that is applicable to updating first payee contact 142a or creating second payee contact 142b. In an example, payee attribute change information 240 indicates a change from first payee 106 to second payee 112 for future payments. At fourth time “4”, communication device creates second payee contact 142b associated with second payee 112 and containing payee attributes required for the future payments to be sent to second payee 112. At fifth time “5”, communication device 100 generates second future payment initiation information 236b using second payee contact 142b. Communication device 100 also transmits, via communications subsystem 114 and wired or wireless channel 115a, second future payment initiation information 236b to third payment system 107c. At a sixth time “6”, third payment system 107c uses payee attributes included in second future payment initiation information 236b to generate and transmit second future payment 238b to second payee account 232b via second payment system 107b.

In one or more embodiments, processor 130 is further configured to cause communication device 100 to periodically monitor communication records received by communication device 100 for a change notice containing the change in the at least one payee attribute of the payee. Processor 130 is further configured to cause communication device 100 to parse the received communication for information providing the changes in the at least one payee attributes.

With particular reference to FIG. 1, according to aspects of the present disclosure, an electronic device such as communication device 100 includes at least one input device 154 and at least one output device 162. Communication device 100 has memory 122 including (i) personal knowledge base (PKB) 141 that includes payee contact 142 having at least one payee attribute of payee (106); and (ii) payment module 134 for a transaction that is, or includes, a future payment to payee (106) using at least in part the at least one payee attribute. Communication device 100 includes communications subsystem 114 that links communication device 100 to at least one payment system 107 having a payment account (first payee account 232a of FIG. 2) associated with the payee (106). Processor 130 of communication device 100 is communicatively coupled to at least one input device 154, at least one output device 162, memory 122, and communications subsystem 114. In response to identifying a reported change of the at least one payee attribute associated with the future payment to the payee (106) associated with the transaction, processor 130 is configured to cause communication device 100 to generate and present a notice, via at least one output device 162, of the reported change required in at least one payee attribute associated with the transaction. In response to receiving a user input to record a corresponding change to the at least one payee attribute corresponding to the reported change, processor 130 is configured to cause communication device 100 to update the at least one payee attribute stored in payee contact 142 associated with the future payment for the transaction.

In one or more embodiments, processor 130 is further is configured to cause communication device 100 to periodically monitor communication records received by communication device 100 for a change notice containing the change in the at least one payee attribute of the payee. In one or more particular embodiments, the communications records include at least one communication type from among a group comprising: (i) emails; (ii) text messages; and (iii) electronic notifications. In one or more embodiments, the at least one payee attribute includes at least one of: a name of the payee; a payment account of the payee; a payment account identifier; and a name, a payment account and a payment account identifier of the payee.

In one or more embodiments, processor 130 is further is configured to cause communication device 100 to determine that the change in the at least one payee attribute includes a change in at least the payment account for completing the transaction from a first payee account 232a (FIG. 2) having an associated first payment identifier to a second payee account 232b (FIG. 2) having an associated second payment identifier. Processor 130 is further is configured to cause communication device 100 to generate and present the notice of a change in at least one of a payee name and the transaction account for the payee, which is/are identified by a respective payment identifier. In one or more particular embodiments, the first payment identifier corresponds to a first provider of a good or service receiving the payment from the transaction and the second payment identifier corresponds to a second provider that has replaced the first provider in the transaction. In one or more particular embodiments, the first payee account and second payee account are different payment accounts of a same payee.

In one or more particular embodiments, processor 130 is further is configured to cause communication device 100 to determine a change date from the first payment identifier to the second payment identifier. In response to receiving authorization to process the future payment that is scheduled for a payment date, processor 130 is further is configured to cause communication device 100 to complete payment for the transaction using the first payment identifier, when the payment date is before the change date. Processor 130 is further configured to cause communication device 100 to complete payment for the transaction using the second payment identifier, when the payment date is on or after the change date.

In one or more embodiments, the first payment identifier is a first telephone number, and the second payment identifier is a second telephone number. In one or more embodiments, the payee contact includes a descriptive label of a commodity involved in the transaction from among a good or a service provided by a current provider.

In one or more embodiments, in response to being within a threshold period of time from a next future payment, processor 130 is further is configured to cause communication device 100 to generate and present a payment window, via at least one output device of the electronic device, to solicit user authorization of a payment for the transaction on a payment date. Processor 130 is further configured to cause communication device 100 to generate and present the notice, overlaying the payment window to solicit approval for updating a corresponding payee attribute and performing the future payment using the at least one payee attribute in the payee contact.

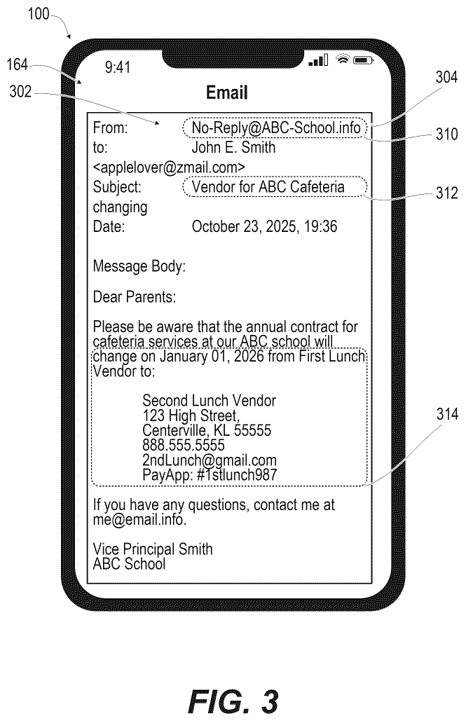

FIG. 3 illustrates an example communication record 302 (i.e., an email) presented in email interface window 304 on display 164 of communication device 100 and that notifies a user of a change in a payee attribute. AI model 137 (FIG. 1) analyzes communication record 302 for an association with the future payments. In an example, AI model 137 (FIG. 1) may identify origination information 310 that is associated with a transaction authority (e.g., landlord or manager 108 (FIG. 1). AI model 137 (FIG. 1) may identify venue information 312 that is managed by a landlord, manager, or other entity (i.e., origin information 310). Venue information 312 may be location specific, indicating venue 105 (FIG. 1) that is associated with the future payments. Alternatively, venue information 312 may not be specifically described, such as for services received at a user location of user 101 (FIG. 1) (e.g., home or landscape renovations, dog walking, etc.). AI model 137 (FIG. 1) may identify change information 314 that that indicates a change in payee attributes (e.g., a date of change from first payee 106 to second payee 112 (FIG. 1)).

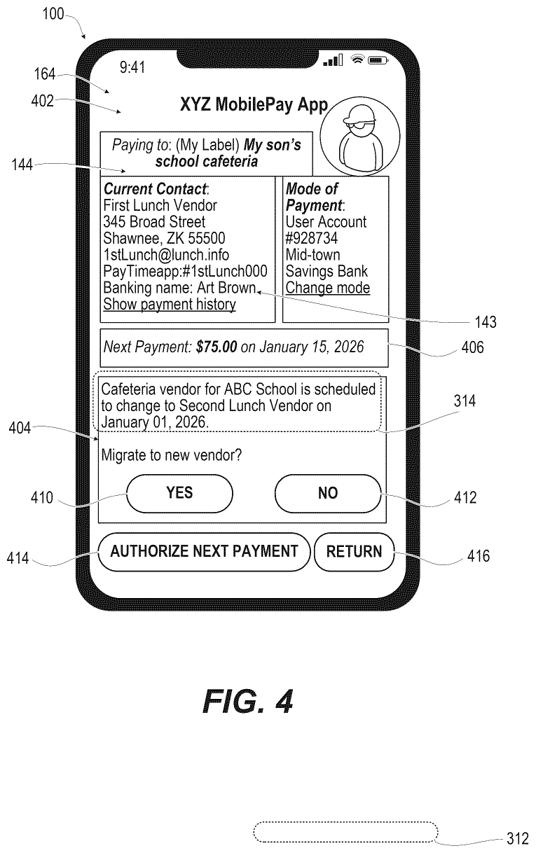

FIG. 4 illustrates payment interface window 402 presented on display 164 of communication device 100 and presenting payee contact update popup 404 in response to the payee attribute change indicated by change information 314. In an example, payment interface window 402 presents information obtained from first payee contact 142a (FIG. 2) that includes payee name 143, goods/service label 144, and payment identifier. Payment interface window 402 also presents change date. Payment interface window 402 includes next future payment information 406. Payee contact update popup 404 presents yes control 410 and no control 412 to respectively accept or not accept the payee attribute change (e.g., associate the future payment after the change date to second payee contact 142b (FIG. 2)). Payment interface window 402 also presents authorize next payment control 414 and return control 416.

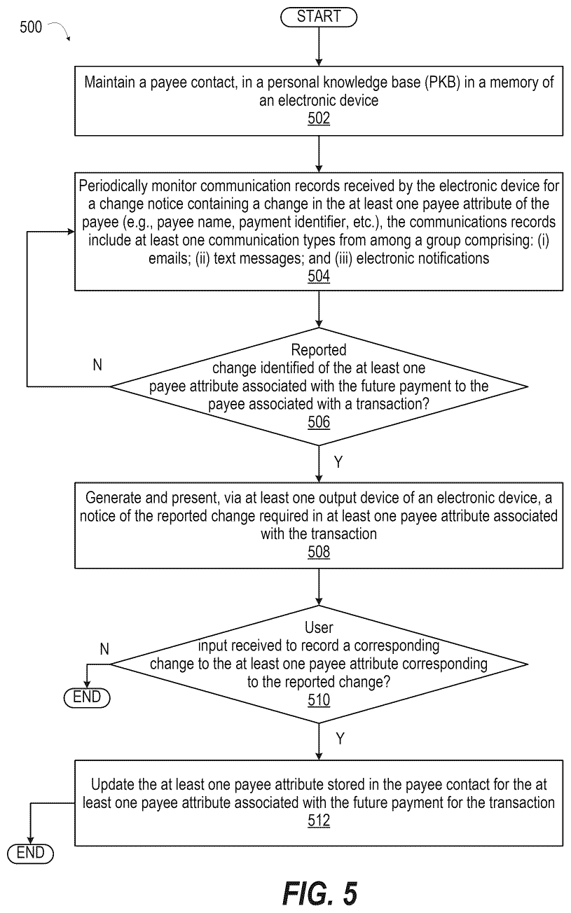

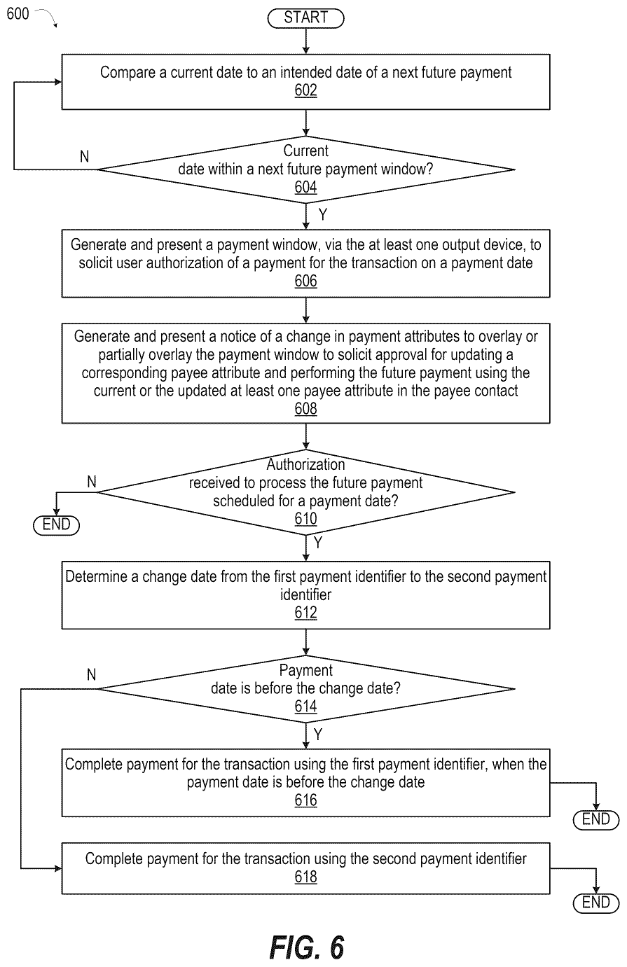

FIG. 5 is a flow diagram presenting a method for updating of payee attributes of a payee contact, the payee attributes used for implementing electronic payments, based on a communicated change. FIG. 6 is a flow diagram presenting a method for initiating the electronic payment using the updated payee attributes. The functionality of method 600 (FIG. 6) may augment the functionality of method 500 (FIG. 5). The descriptions of method 500 (FIG. 5) and method 600 (FIG. 6) are provided with general reference to the specific components illustrated within the preceding FIGS. 1-4 . Specific components referenced in method 500 (FIG. 5) and method 600 (FIG. 6) may be identical or similar to components of the same name used in describing preceding FIGS. 1-4. In one or more embodiments, controller 120 (FIG. 1) configures communication device 100 (FIG. 1) or a similar computing device to provide the described functionality of method 500 (FIG. 5) and method 600 (FIG. 6).

With reference to FIG. 5, method 500 includes maintaining a payee contact in a personal knowledge base (PKB) in a memory of an electronic device (block 502). The payee contact includes at least one payee attribute of a payee used for an ad hoc/recurring/periodic/scheduled future payment. Method 500 includes periodically monitoring communication records received by the electronic device for a change notice containing a change in the at least one payee attribute of the payee (e.g., payee name, payment identifier, etc.), the communications records include at least one communication type from among a group comprising: (i) emails; (ii) text messages; and (iii) electronic notifications (block 504). Method 500 includes determining whether a reported change is identified of the at least one payee attribute associated with the future payment to the payee associated with a transaction (decision block 506). In response to not identifying a reported change of the at least one payee attribute associated with the future payment to the payee associated with a transaction, method 500 returns to block 504. In response to identifying a reported change of the at least one payee attribute associated with the future payment to the payee associated with a transaction, method 500 includes generating and presenting, via at least one output device of an electronic device, a notice of the reported change required in at least one payee attribute associated with the transaction (block 508).

Method 500 includes determining whether a user input is received to record a corresponding change to the at least one payee attribute corresponding to the reported change (decision block 510). In response to not receiving a user input to record a corresponding change to the at least one payee attribute corresponding to the reported change, method 500 returns to block 504. In response to receiving a user input to record a corresponding change to the at least one payee attribute corresponding to the reported change, method 500 includes updating the at least one payee attribute stored in the payee contact for the at least one payee attribute associated with the future payment for the transaction (block 512). Then method 500 ends.

With reference to FIG. 6, method 600 includes comparing a current date to an intended date of a next future payment (block 602). Method 600 includes determining whether a current date is within a next payment window (decision block 604). The next payment may be ad hoc with the intended date triggered by user selection. The next payment window may be a specific date. The next payment window may start immediately after a previous payment and end on a specific date. The next payment window may be a defined date range. In response to determining that the current date is not within the next payment window, method 600 returns to block 602. In response to determining that the current date is not within the next payment window, method 600 includes generating and presenting a payment window, via the at least one output device, to solicit user authorization of a payment for the transaction on a payment date (block 606). Method 600 includes generating and presenting a notice of a change in payment attributes to overlay or partially overlay the payment window (block 608). In one or more embodiments, the notice solicits user approval for updating a corresponding payee attribute and performing the future payment using the current or the updated at least one payee attribute in the payee contact. Method 600 includes determining whether authorization is received to process the future payment scheduled or ad hoc initiated for a payment date (decision block 610). In response to not receiving authorization to process the future payment scheduled for a payment date, method 600 ends. In response to determining that authorization is received to process the future payment scheduled for a payment date, method 600 includes determining a change date (block 612). Method 600 includes determining whether the payment date is before the change date (decision block 614). In response to determining that the payment date is before the change date, method 600 includes completing payment for the transaction using the first payment identifier (block 616). Then method 600 ends. In response to determining that the payment date is on or after the change date, method 600 includes completing payment for the transaction using the second payment identifier (block 618). Then method 600 ends.

According to aspects of the present disclosure, method 600 may include maintaining a payee contact having at least one payee attribute of a payee used for a future payment. In response to identifying a reported change of the at least one payee attribute associated with the future payment to the payee associated with a transaction, method 600 may include generating and presenting a notice, via at least one output device of an electronic device, of the reported change required in at least one payee attribute associated with the transaction. In response to receiving a user input to record a corresponding change to the at least one payee attribute corresponding to the reported change, method 600 may include updating the at least one payee attribute stored in the payee contact for the at least one payee attribute associated with the future payment for the transaction.

In one or more embodiments, method 600 may further include periodically monitoring communication records received by the electronic device for a change notice containing the change in the at least one payee attribute of the payee. Method 600 may further include parsing the received communication for information providing the changes in the at least one payee attributes. The communications records may include at least one communication types from among a group comprising: (i) emails; (ii) text messages; and (iii) electronic notifications.

In one or more embodiments, method 600 may further include determining that the change in the at least one payee attribute comprises a change in at least a payment account for completing the transaction from a first payee account having an associated first payment identifier to a second payee account having an associated second payment identifier. Method 600 may further include generating and presenting the notice of a change in at least one of a payee name and the transaction account for the payee identified by a respective payment identifier. In one or more particular embodiments, the first payment identifier corresponds to a first provider of a good or service receiving the payment from the transaction and the second payment identifier corresponds to a second provider that has replaced the first provider in the transaction.

In one or more particular embodiments, method 600 may further include determining a change date from the first payment identifier to the second payment identifier. In response to receiving authorization to process the future payment scheduled or ad hoc initiated for a payment date, method 600 may further include completing payment for the transaction using the first payment identifier, when the payment date is before the change date. Method 600 may further include completing payment for the transaction using the second payment identifier, when the payment date is on or after the change date.

In one or more embodiments, the first payment identifier is a first telephone number and the second payment identifier is a second telephone number. In one or more embodiments, in response to being within a threshold period of time from a next future payment, method 600 may include generating and presenting a payment window, via the at least one output device, to solicit user authorization of a payment for the transaction on a payment date. Method 600 may further include generating and presenting the notice, overlaying the payment window to solicit approval for updating a corresponding payee attribute and performing the future payment using the correct, updated at least one payee attribute in the payee contact.

According to aspects of the present disclosure, the communication device 100 (FIG. 1), method 500 (FIG. 5), method 600 (FIG. 6) and computer program product, such as RSD 150 (FIG. 1), provide techniques for updating of a payee attributes for future electronic payment(s) in a payee contact based on a communicated change. periodically monitor communication records received by the electronic device for a change notice such as (i) emails; (ii) text messages; and (iii) electronic notifications. In one or more embodiments, the techniques detect and respond to a change in the payee attribute(s) of one or more of a name of the payee; a payment account (e.g., telephone number, banking account, or payment app identifier) of the payee; a payment account identifier; and a name, a payment account and a payment account identifier of the payee. The techniques simplify authorizing a future payment by automatically detecting changes in payment attributes for a user, based on a received communication. By prompting authorization to update the payment attributes and make a payment using the updated payment attributes, instances of ineffective or incorrect transfer/payment of funds to the wrong party are avoided.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

1. An electronic device comprising:
at least one input device;
at least one output device;
a memory comprising (i) a personal knowledge base (PKB) comprising a payee contact having at least one payee attribute of a payee; and (ii) a payment module for a transaction comprising a future payment to the payee using at least in part the at least one payee attribute;
a communications subsystem that links the electronic device to at least one payment system having a payment account associated with the payee; and
a processor communicatively coupled to the at least one input device, the at least one output device, the memory, and the communications subsystem, and which is configured to cause the electronic device to:
receive, via the communications subsystem, information of a change in electronic payee attribute associated with a payment account;
in response to identifying a reported change of the at least one payee attribute associated with the future payment to the payee associated with the transaction:
generate and present a notice, via the at least one output device, of the reported change required in at least one payee attribute associated with the transaction; and
in response to receiving a user input to record a corresponding change to the at least one payee attribute corresponding to the reported change, update the at least one payee attribute stored in the payee contact in the PKB, the at least one payee attribute associated with the future payment for the transaction, wherein the PKB is updated.

2. The electronic device of claim 1, wherein to identify the reported change in electronic payee attribute, the processor is further configured to cause the electronic device to:
periodically monitor communication records received by the electronic device for a change notice containing the change in the at least one payee attribute of the payee; and
parse the received communication for information providing the changes in the at least one payee attributes.

3. The electronic device of claim 2, wherein the communications records comprise at least one communication type from among a group comprising: (i) emails; (ii) text messages; and (iii) electronic notifications.

4. The electronic device of claim 1, wherein the at least one payee attribute comprises at least one of: a name of the payee; a payment account of the payee; a payment account identifier; and a name, a payment account and a payment account identifier of the payee.

5. The electronic device of claim 4, where the at least one payee attribute comprises a telephone number as the payment account identifier.

6. The electronic device of claim 1, wherein the processor is further configured to:
determine that the change in the at least one payee attribute comprises a change in at least the payment account for completing the transaction from a first payee account having an associated first payment identifier to a second payee account having an associated second payment identifier; and
generate and present the notice of a change in at least one of a payee name and the transaction account for the payee identified by a respective payment identifier.

7. The electronic device of claim 6, wherein the first payment identifier corresponds to a first provider of a good or service receiving the payment from the transaction and the second payment identifier corresponds to a second provider that has replaced the first provider in the transaction.

8. The electronic device of claim 6, wherein the first payee account and second payee account are different payment accounts of a same payee.

9. The electronic device of claim 6, wherein the processor is further configured to cause the electronic device to:
determine a change date from the first payment identifier to the second payment identifier; and
in response to receiving authorization to process the future payment scheduled for a payment date:
complete payment for the transaction using the first payment identifier, when the payment date is before the change date; and
complete payment for the transaction using the second payment identifier, when the payment date is on or after the change date.

10. The electronic device of claim 9, wherein the first payment identifier is a first telephone number and the second payment identifier is a second telephone number.

11. The electronic device of claim 1, wherein the payee contact comprises a descriptive label of a commodity involved in the transaction from among a good or a service provided by a current provider.

12. The electronic device of claim 1, wherein the processor is further configured to cause the electronic device to:
in response to being within a threshold period of time from a next future payment, generate and present a payment window, via at least one output device of the electronic device, to solicit user authorization of a payment for the transaction on a payment date; and
generate and present the notice, overlaying the payment window to solicit approval for updating a corresponding payee attribute and performing the future payment using the at least one payee attribute in the payee contact.

13. A method comprising:
maintaining, by a processor of an electronic device, within a personal knowledge base (PKB), a payee contact having at least one payee attribute of a payee used for a future payment;
receiving, via a communications subsystem of the electronic device, information of a change in electronic payee attribute associated with a payment account; and
in response to identifying a reported change of the at least one payee attribute associated with the future payment to the payee associated with a transaction:
generating and presenting a notice, via at least one output device of an electronic device, of the reported change required in at least one payee attribute associated with the transaction; and
in response to receiving a user input to record a corresponding change to the at least one payee attribute corresponding to the reported change, updating the at least one payee attribute stored in the payee contact in the PKB, the at least one payee attribute associated with the future payment for the transaction, wherein the PKB is updated.

14. The method of claim 13, further comprising:
periodically monitoring communication records received by the electronic device for a change notice containing the change in the at least one payee attribute of the payee, the communications records comprise at least one communication types from among a group comprising: (i) emails; (ii) text messages; and (iii) electronic notifications; and
parsing the received communication for information providing the changes in the at least one payee attributes.

15. The method of claim 13, further comprising:
determining that the change in the at least one payee attribute comprises a change in at least a payment account for completing the transaction from a first payee account having an associated first payment identifier to a second payee account having an associated second payment identifier; and
generating and presenting the notice of a change in at least one of a payee name and the transaction account for the payee identified by a respective payment identifier.

16. The method of claim 14, wherein the first payment identifier corresponds to a first provider of a good or service receiving the payment from the transaction and the second payment identifier corresponds to a second provider that has replaced the first provider in the transaction.

17. The method of claim 15, further comprising:
determining a change date from the first payment identifier to the second payment identifier; and
in response to receiving authorization to process the future payment scheduled for a payment date:
completing payment for the transaction using the first payment identifier, when the payment date is before the change date; and
completing payment for the transaction using the second payment identifier, when the payment date is on or after the change date.

18. The method of claim 17, wherein the first payment identifier is a first telephone number and the second payment identifier is a second telephone number.

19. The method of claim 13, further comprising:
in response to being within a threshold period of time from a next future payment, generating and presenting a payment window, via the at least one output device, to solicit user authorization of a payment for the transaction on a payment date; and
generating and presenting the notice, overlaying the payment window to solicit approval for updating a corresponding payee attribute and performing the future payment using the at least one payee attribute in the payee contact.

20. A computer program product comprising:
a computer readable storage device; and
program code on the computer readable storage device that when executed by a processor associated with an electronic device, the program code is configured to cause the electronic device to provide functionality of:
maintaining, within a personal knowledge base (PKB), a payee contact having at least one payee attribute of a payee used for a future payment;
receiving, via a communications subsystem of the electronic device, information of a change in electronic payee attribute associated with a payment account; and
in response to identifying a reported change of the at least one payee attribute associated with the future payment to the payee associated with a transaction:
generating and presenting a notice, via at least one output device of the electronic device, of the reported change in at least one payee attribute associated with the transaction; and
in response to receiving a user input to record a corresponding change to the at least one payee attribute corresponding to the reported change, updating the at least one payee attribute stored in the payee contact in the PKB, the at least one payee attribute associated with the future payment for the transaction, wherein the PKB is updated.
